(19) United States
(12) Patent Application Publication
(10) Pub. No.: US 2010/0135626 A1
(43) Pub. Date: Jun. 3, 2010

(54) WAVEGUIDE HAVING A CLADDED CORE FOR GUIDING TERAHERTZ WAVES

(75) Inventors: Chi-Kuang Sun, Taipei (TW); Hung-Chun Chang, Taipei (TW); Chih-Hsien Lai, Taichung City (TW); Yu-Chun Hsueh, Taichung City (TW)

Correspondence Address: OCCHIUTI ROHLICEK & TSAO, LLP, 10 FAWCETT STREET, CAMBRIDGE, MA, 02138, US

(73) Assignee: National Taiwan University, Taipei (TW)

(21) Appl. No.: 12/536,072

(22) Filed: Aug. 5, 2009

(30) Foreign Application Priority Data
Nov. 28, 2008 (TW) 097146233

(51) Int. Cl. G02B 6/02

(52) U.S. Cl. 385/123

(57) ABSTRACT

A waveguide for guiding terahertz waves with wavelength ranging 0.1 mm-3 mm, includes a cladding tube made of a metal-free dielectric material, and a core filling a transmission space defined by the cladding tube. The core has a minimum width or diameter larger than the wavelength of the terahertz wave guided by the waveguide. The thickness of the cladding tube is smaller than the radius or one half of the width of the core. The core has an attenuation constant for the terahertz waves lower than that of the cladding tube. The waveguide guides terahertz waves mainly inside the core, and has a simple construction.

### CROSS-REFERENCE TO RELATED APPLICATIONS

This application claims priority from Taiwanese Invention Patent Application No. 097146233 filed on Nov. 28, 2008.

### BACKGROUND OF THE INVENTION

1. Field of the Invention

This application relates to a waveguide, more particularly to a simple dielectric waveguide having a cladded core for guiding terahertz (THz) waves.

2. Description of the Related Art

Terahertz waves are electromagnetic waves with frequencies ranging from 0.1 GHz to 3 GHz, which are referred to T-rays. The frequencies of the terahertz waves lie between high frequency microwaves and far-infrared rays, and physical characteristics of the terahertz waves are different from other electromagnetic waves, such as visible light, non-visible light, microwaves, X-rays, etc. Therefore, waveguides usable for such other electromagnetic waves are not suitable for guiding terahertz waves.

In recent years, there has been an increasing focus on terrorism efforts. Due to the fact that terahertz waves can penetrate non-transparent articles, such as paper and clothes, and can interact with metals and biomolecules, the terahertz waves can be used to detect illegal articles, such as weapons, explosives, and drugs which are hidden behind clothes, and can even be used to detect viruses. In addition, terahertz waves are non-ionization radiations, and so are not as risky as X-rays which may cause cancer and lead to other medical problems.

Most metal-based waveguides which have been used for guiding terahertz waves are made from a material that is blended with a metal or plated with a metal or alloy, or a ferroelectric material. They are constructed as a metal parallel plate, a bare metal wire, a hollow tube, etc.

Examples of the related prior art are disclosed in the following: (1) “Ferroelectric All-Polymer Hollow Bragg Fibers for Terahertz Guidance,” Maksim Skorobogatiy and Alexandre Dupuis, Applied Physics Letters, vol. 90, 113514, 2007; (2) “Ferroelectric PVDF Cladding Terahertz Waveguide,” Takehiko Hidaka et al, Journal of Lightwave Technology, vol. 23, No. 8, Aug. 2005; (3) “Silver/Polystyrene-Coated Hollow Glass Waveguides for the Transmission of Terahertz Radiation” Bradley Bowden et al, Optics Letters, vol. 32, No. 20, Oct. 15, 2007; and (4) “Low-index Discontinuity Terahertz Waveguides” Michael Nagel et. al, Optics Express 9944, vol. 14, No. 21, Oct. 16, 2006. The prior arts are directed to the development of metal waveguides using high refractive indexes and low absorption characteristics of metals in an effort to ensure low attenuation during transmission of terahertz waves.

Other examples of the related prior art are disclosed in the following articles: “Proposal for Ultra-low Loss Hollow-Core Plastic Bragg Fiber with Cobweb-Structured Cladding for Terahertz Waveguiding” Rong-Jin Yu et. al, IEEE Photonics Technology Letters, vol. 19, No. 12, Jun. 15, 2007, and “Terahertz Air-Core Microstructure Fiber” Ja-Yu Lu et. al., Applied Physics Letters vol. 92, pp 064105, 2008. The aforesaid articles suggest non-metal waveguide structures for guiding terahertz waves, which include multiple hollow plastic tubes, or layered periodic structures formed from non-uniform tube walls stacked in an axial direction or a direction perpendicular to the axial direction.

U.S. Pat. No. 7,409,132 B2 owned by the applicant of this application discloses a plastic waveguide for guiding terahertz waves, which is similar to an optical fiber and which are suitable for terahertz waves having a wavelength ranging from 30 to 3000 μm. The plastic waveguide has a cladding layer surrounding a core and having a refractive index lower than that of the core. The core has a maximum diameter smaller than the wavelength of the guided terahertz waves. The terahertz waves are mainly guided in the cladding layer.

### SUMMARY OF THE INVENTION

An object of the present invention is to provide a simple dielectric waveguide which guides terahertz waves mainly inside a cladded core.

According to the present invention, a waveguide for guiding a terahertz wave with a wavelength ranging from 0.1 to 3 mm is provided. The waveguide comprises a single layer cladding tube made of a metal-free dielectric material. The cladding tube has an inner peripheral surface, an outer peripheral surface surrounding the inner peripheral surface, and a thickness defined between the inner and outer peripheral surfaces. The inner peripheral surface confines a transmission space. The waveguide further comprises a core filling the transmission space. The core has a refractive index lower than that of the cladding tube and a minimum width larger than the wavelength of the guided terahertz wave. The thickness of the cladding tube is smaller than one half of the width of the core. The core has an attenuation constant for the guided terahertz waves lower than that of the cladding tube.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a terahertz waveguide according to a preferred embodiment of the present invention;

FIG. 2 shows the fundamental mode energy intensity distributions of different frequency terahertz waves in the waveguide having 9 mm inner diameter and 10 mm outer diameter;

FIG. 3 shows the fundamental mode energy intensity distributions of different frequency terahertz waves in the waveguide having a 9 mm inner diameter and a 11 mm outer diameter;

FIG. 4 is a dispersion diagram of the fundamental waveguide mode showing the real part of equivalent refractive index as a function of frequency for two waveguides both of which are with 1 mm thick cladding and which respectively have 7 mm and 9 mm in inner diameter;

FIG. 5 is a loss coefficient diagram of the fundamental waveguide mode showing attenuation constant as a function of frequency for two waveguides both of which are with 1 mm thick cladding and which respectively have 7 mm and 9 mm in inner diameter;

FIG. 6 is a dispersion diagram of the fundamental waveguide mode showing the real part of equivalent refractive index as a function of frequency for two waveguides which respectively have 0.5 mm and 1 mm in cladding thickness and both of which have 9 mm in inner diameter;

FIG. 7 is a loss coefficient diagram of the fundamental waveguide mode showing attenuation constant as a function of frequency for two waveguides both of which have 9 mm in inner diameter and which respectively have 0.5 mm and 1 mm in thickness.

FIG. 8 is a dispersion diagram of the fundamental waveguide mode showing the real part of equivalent refractive index as a function of frequency for two waveguides with claddings made from lossless materials and lossy materials, respectively;

FIG. 9 is a loss coefficient diagram of the fundamental waveguide mode showing the attenuation constant as a function of frequency for two waveguides with claddings made from lossless materials and lossy materials, respectively;

FIG. 10 is a dispersion diagram of the fundamental waveguide mode showing real part of equivalent refractive index as a function of frequency for two waveguides both of which have 9 mm in inner diameter and which respectively have 1 mm and 1.1 mm in thickness;

FIG. 11 is a loss coefficient diagram of the fundamental waveguide mode showing the attenuation constant as a function of frequency for two waveguides both of which have 9 mm in inner diameter and which respectively have 1 mm and 1.1 mm in thickness;

FIG. 12 shows energy intensity distributions for eleven different guiding modes in the waveguide;

FIG. 13 shows the imaginary part of equivalent refractive index as a function of the real part of equivalent refractive index for the eleven different guiding modes in the waveguide;

FIG. 14 shows the attenuation constant of the fundamental waveguide mode as a function of frequency for the waveguides with the same cladding thickness of 0.5 mm and with, different core diameters which are 5 mm, 7 mm and 9 mm;

FIG. 15 shows the attenuation constant of the fundamental waveguide mode as a function of frequency for the waveguides having different cladding refractive indexes which are 1.4 and 1.6, and having the same cladding thickness of 0.5 mm, and the same core diameter of 9 mm;

FIG. 16 shows the attenuation constant of the fundamental waveguide mode as a function of core diameter plotted based on the waveguides having the same cladding thickness of 0.5 mm and the same refractive index of 1.4; and

FIG. 17 shows bending loss of a Teflon pipe waveguide as a function of radius of the pipe after the pipe is bent.

### DETAILED DESCRIPTION OF THE PREFERRED EMBODIMENTS

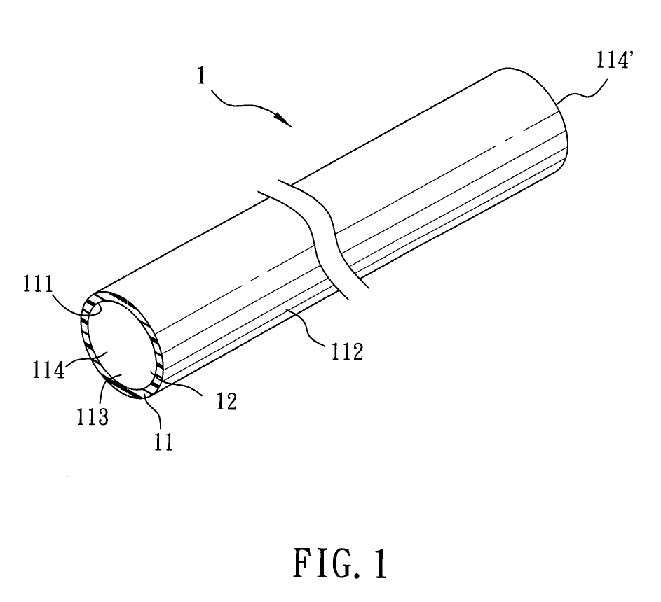

Referring to FIG. 1, there is shown a waveguide 1 according to a preferred embodiment of the present invention for guiding terahertz waves having frequencies ranging from 100 GHz-3000 GHz and wavelengths ranging from 0.1-3 mm. The waveguide 1 is a longitudinal straight body which includes a cladding tube 11 and a core 12.

The cladding tube 11 is a single layer cladding tube made of a metal-free material, particularly a single dielectric material that does not contain any ferroelectric material. Examples of the dielectric material are polytetrafluoroethylene (Teflon), polyethylene, glass, etc. The cross section of the cladding tube 11 may be circular, rectangular, elliptical, or in other suitable shape. The cladding tube 11 has an inner peripheral surface 111, and an outer peripheral surface 112. The inner peripheral 111 defines a transmission space 113 having two opposite open ends 114, 114′. The transmission space 113 has a minimum width or diameter larger than the wavelength of the terahertz waves guided by the waveguide 1. The distance between the inner and outer peripheral surfaces 111, 112 is the thickness that determines the bandwidth of the terahertz waves to be transmitted. The core 12 fills the transmission space 113.

The thickness of the cladding tube 11 may be uniform or non-uniform. Preferably, the thickness of the cladding tube 11 is uniform. In an embodiment, the thickness of the cladding tube 11 is smaller than the radius or one half of the width of the transmission space 113 or the core 12. In another embodiment, the thickness of the cladding tube 11 is smaller than the wavelength of the guided terahertz waves. Particularly, the thickness of the cladding tube maybe 0.05 mm-3 mm, preferably, 0.05 mm-2 mm, more preferably 0.1 mm-1 mm.

The core 12 has a refractive index lower than that of the cladding tube 11. The minimum width or diameter of the core 12 is larger than the wavelength of the guided terahertz waves. Preferably, the minimum width or diameter of the core 12 is at least twice the wavelength of the guided terahertz waves. The core 12 may be made of dry air, moisture-free gas, moisture-containing air, or a vacuum. As a result, the waveguide 1 has a hollow pipe configuration, and the core 12 and the inner and outer peripheral surfaces 111, 112 of the cladding tube 11 cooperatively generate an anti-Fabry-Perot resonance effect that enables the terahertz waves to be transmitted from the open end 114 to the open end 114′.

Numerical and experimental characterization of the frequency-dependent transmission behavior of the waveguidies according to the present invention demonstrates that there are cladding modes with fields confined within the cladding region and core modes with fields confined in the core region. The cladding modes are guided based on the total internal reflection owing to the higher refractive index of the cladding tube 11. However, the cladding modes attenuate rapidly and have relatively high attenuation constant compared to that of the core modes since high material absorption losses are encountered. As the refractive index of the core 12 is less than that of the cladding tube 11, fields will oscillate and radiate through the cladding tube 11 which makes the core modes leaky. However, as the core modes suffer less material absorption losses than the cladding modes, they are the dominant guiding modes in the waveguide 1. The waveguide 1 can successfully confine the guided terahertz waves inside the core 12 with a reasonably low attenuation constant on the order of or lower than 0.01 cm⁻¹.

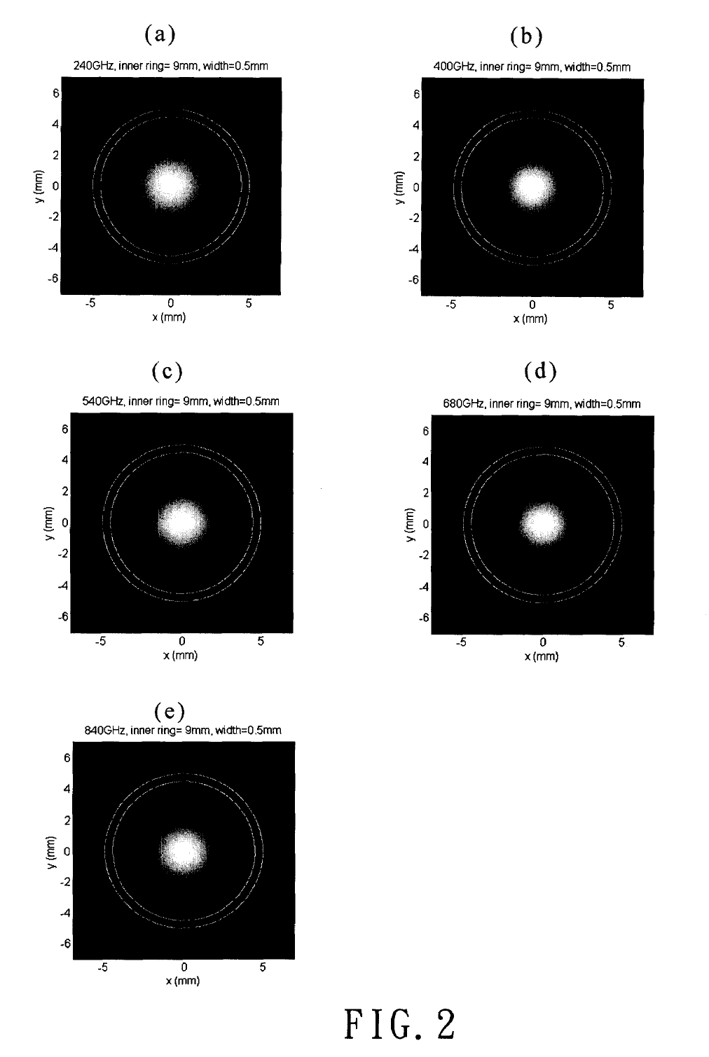

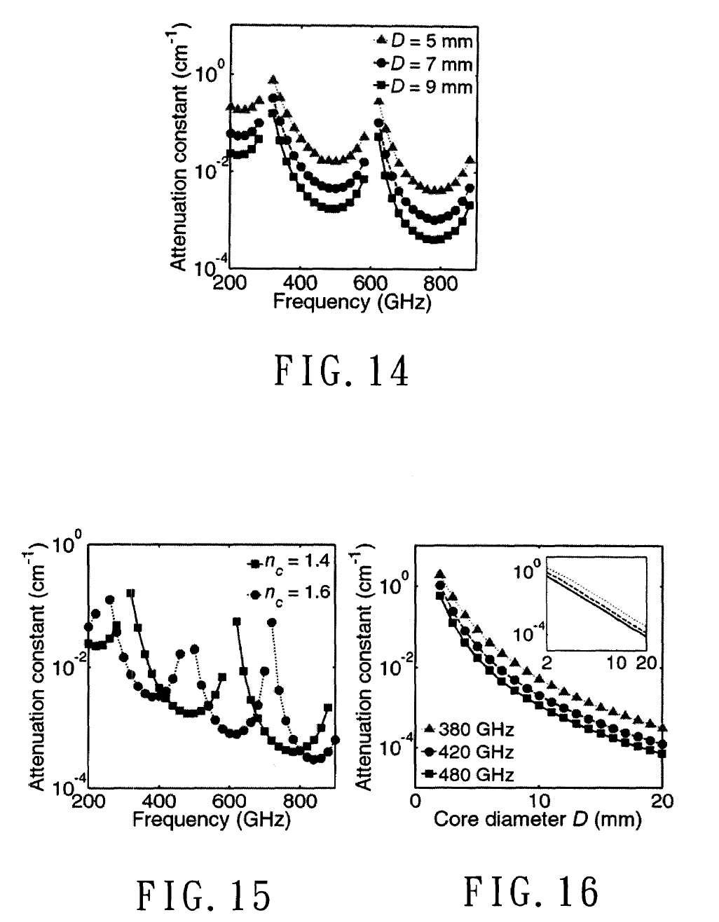

FIGS. 2-17 show results of simulation and experiments for Teflon tube (refractive index=1.4) waveguides.

FIG. 2 shows fundamental mode energy intensity distributions in the waveguide 1 for (a) 240 GHz, (b) 400 GHz, (c) 540 GHz, (d) 680 GHz and (e) 840 GHz. The cladding tube 11 of the waveguide 1 is made of Teflon and has an outer diameter of 10 mm and an inner diameter of 9 mm. Therefore, the diameter or the width of the core is 9 mm, and the thickness of the cladding tube 11 is 0.5 mm. The core 12 is made of moisture-free air. FIG. 2 manifests that terahertz waves with different frequencies are indeed guided inside the core 12.

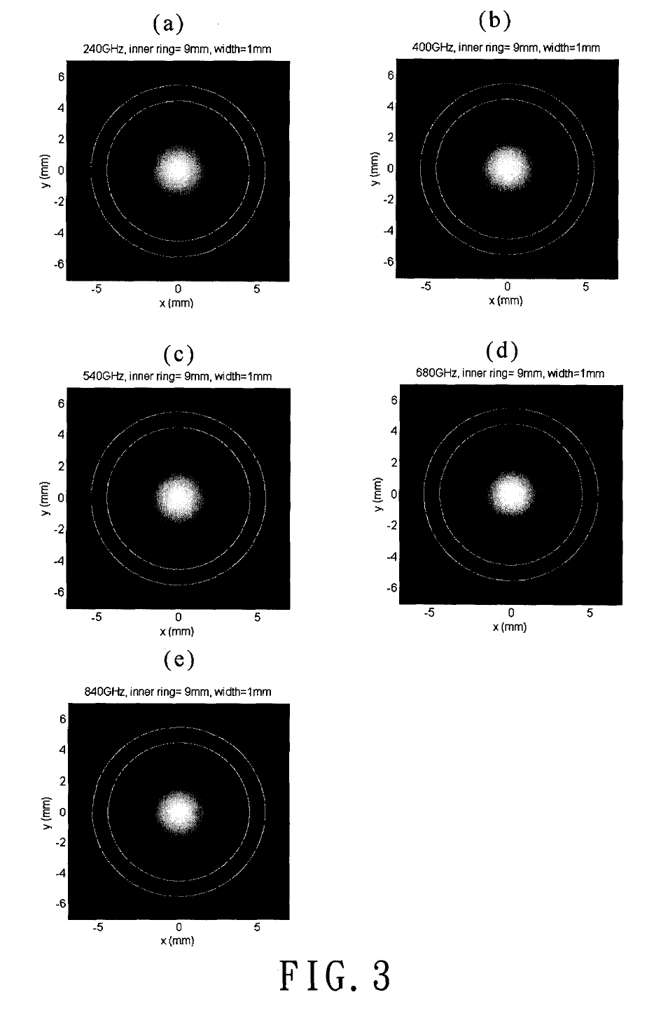

FIG. 3 shows fundamental mode intensity distributions in the waveguide 1 for (a) 240 GHz, (b) 400 GHz, (c) 540 GHz, (d) 680 GHz and (e) 840 GHz. The cladding tube 11 has an outer diameter of 11 mm and an inner diameter of 9 mm. Therefore, the diameter or the width of the core 12 is 9 mm, and the thickness of the cladding tube 11 is 1 mm. The core 12 is made of moisture-free air. FIG. 3 also manifests that terahertz waves with different frequencies are indeed guided inside the core 12.

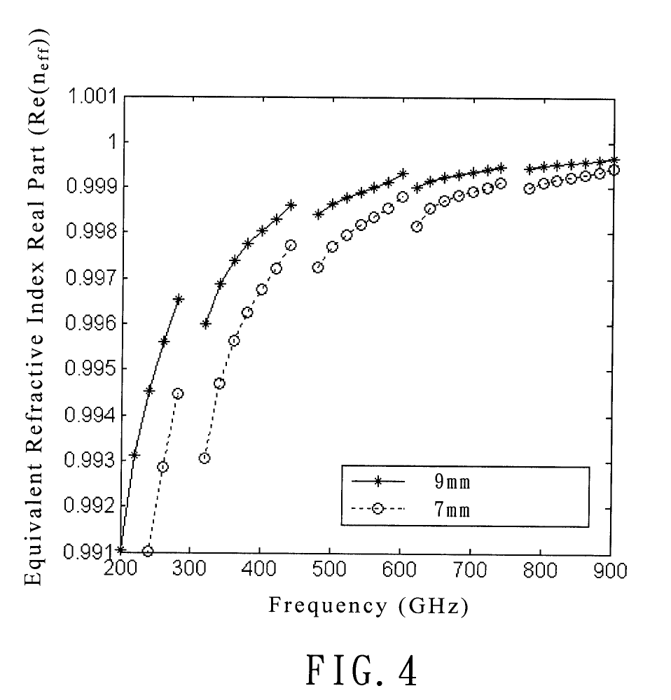

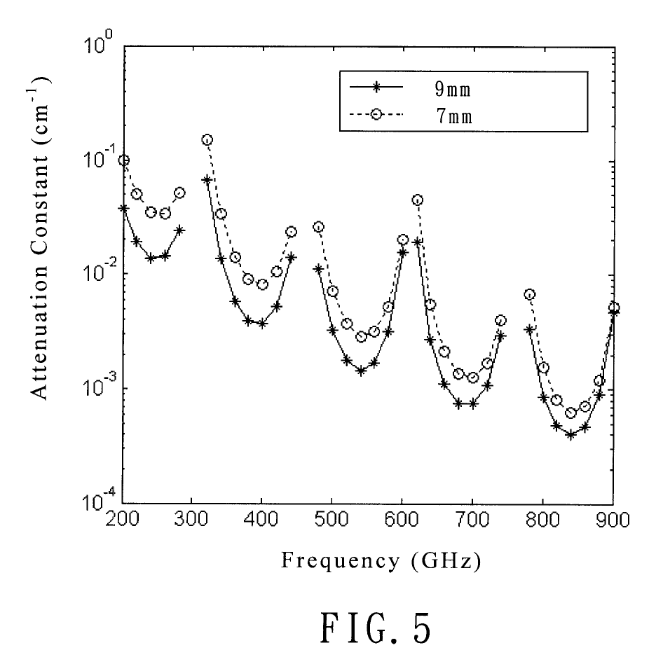

FIGS. 4 and 5 are respectively a dispersion diagram and a loss coefficient diagram of the fundamental guiding mode for two waveguides 1 made of Teflon. The thickness of the cladding tubes 11 of the waveguides 1 is 1 mm, the inner diameters of the cladding tubes 11 are 7 mm and 9 mm, respectively, and the cores 12 of the waveguides 1 are made of moisture-free air. FIGS. 4 and 5 show that discontinuity occurs at the frequencies near 300 GHz, 450 GHz, 600 GHz and 750 GHz. The frequency discontinuity results from the Fabry-Perot resonance effect that is generated by the inner and outer peripheral surfaces 111, 112 of the cladding tube 11 near the aforesaid frequencies so that no core mode exists. The results prove that the waveguide 1 according to the present invention transmits the terahertz wave through an anti Fabry-Perot resonance effect generated by the inner and outer peripheral surfaces 111, 112 of the cladding tube 11.

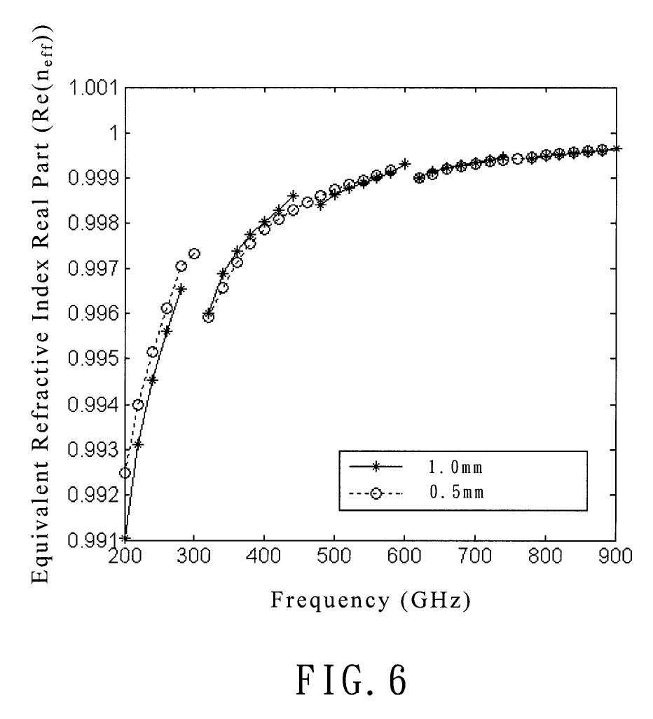

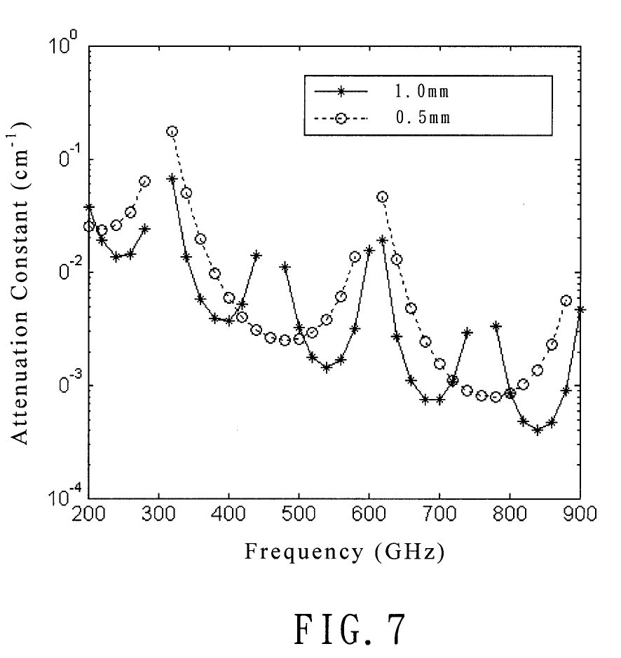

FIGS. 6 and 7 are respectively a dispersion diagram and a loss coefficient diagram of the fundamental guiding mode in two waveguides 1 made of Teflon. The inner diameters of the cladding tubes 11 of the waveguides 1 are 9 mm and are the same, and the outer diameters thereof are varied so as to vary the thickness (d) of the cladding tubes 11. The cores 12 of the waveguides 1 are made of moisture-free air. FIGS. 6 and 7 show that, when the thickness of the cladding tube 11 is increased from 0.5 mm to 1.0 mm, frequency spacing (Δf) between the neighboring discontinuities is reduced to half and is in agreement with the following relation: Δf∝1/d. The results further prove that the waveguide 1 according to the present invention guides the terahertz wave through an anti-Fabry-Perot resonance effect generated by the inner and outer peripheral surfaces 111, 112 of the cladding tube 11.

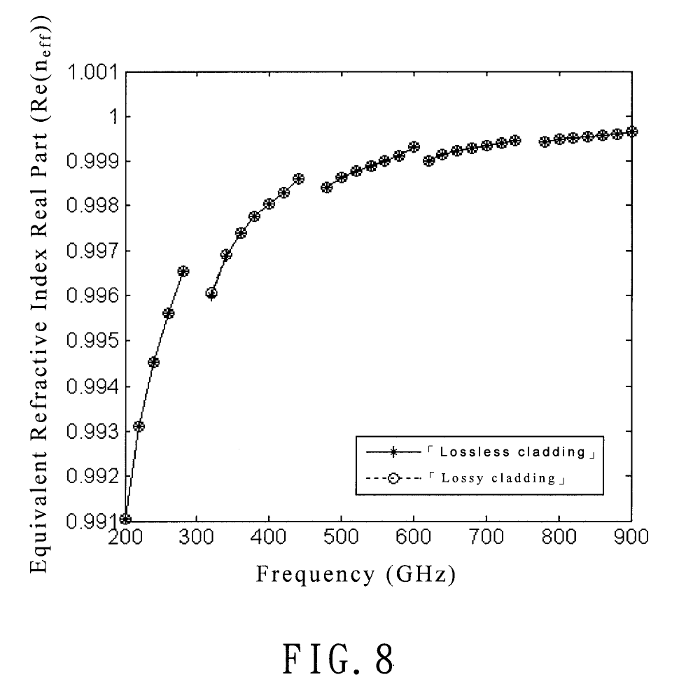

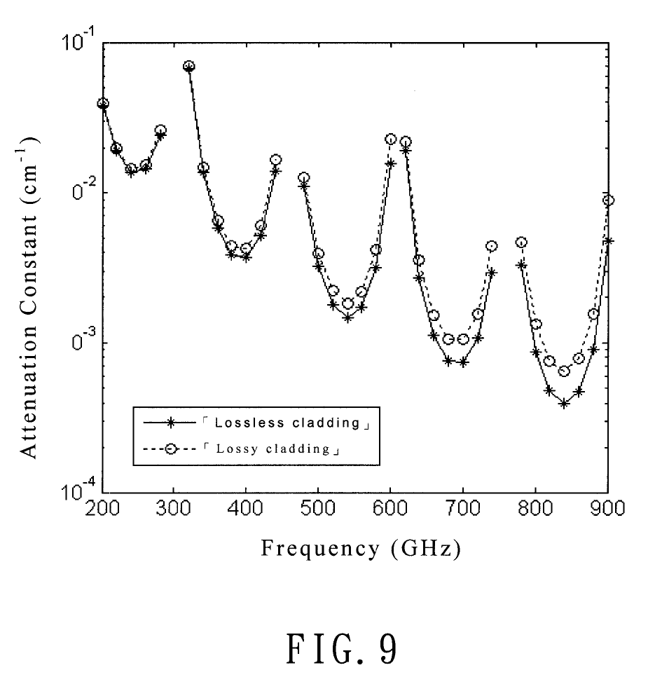

FIGS. 8 and 9 are respectively a dispersion diagram and a loss coefficient diagram of the fundamental guiding mode in two waveguides 1 according to the present invention. The waveguides 1 are respectively made of lossy and lossless Teflon, the cladding tubes 11 thereof have an inner diameter of 9 mm and an outer diameter of 10 mm, and the cores 12 are made of moisture-free air. FIGS. 8 and 9 show that the loss coefficient increases insignificantly when absorption of cladding occurs. In other words, when the cladding is composed of lossy material, the transmission effect of the terahertz waveguide 1 is not significantly affected.

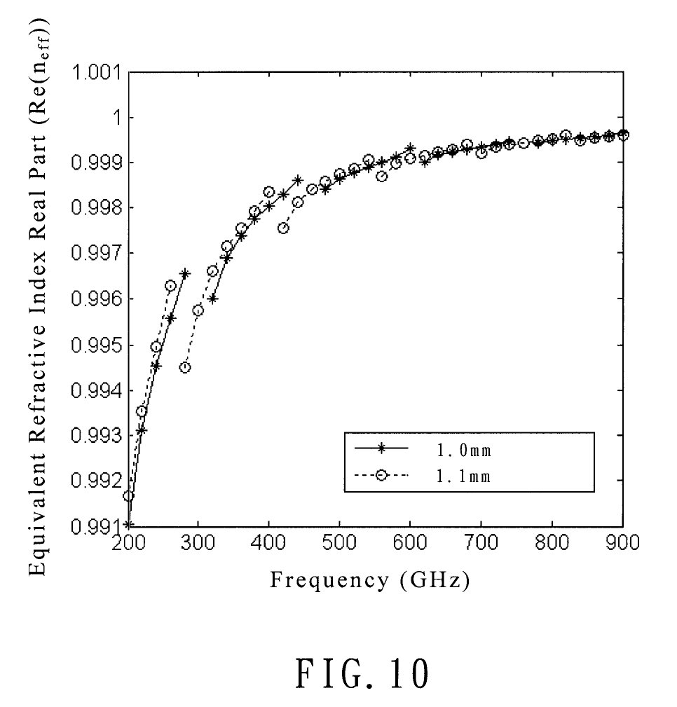

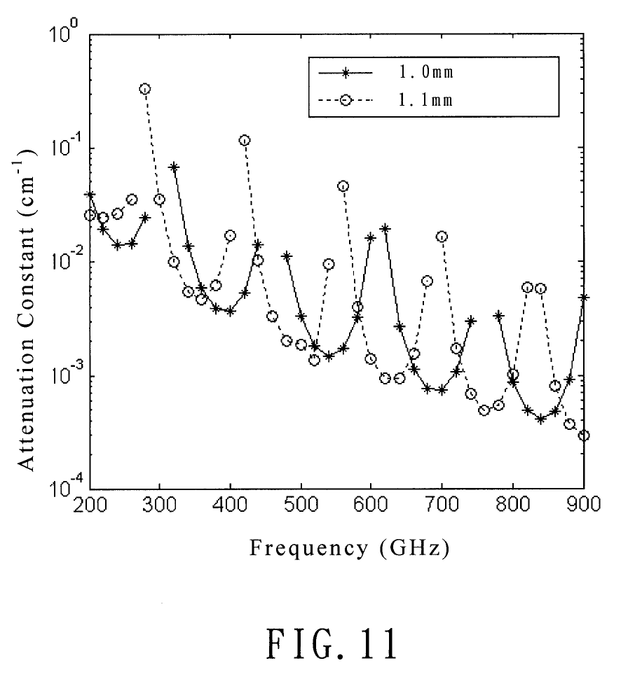

FIGS. 10 and 11 are respectively a dispersion diagram and a loss coefficient diagram of the fundamental guiding mode in two waveguides 1 according to the present invention. The waveguides 1 are made of Teflon, the inner diameters of the cladding tubes 11 thereof are 9 mm, the thicknesses thereof are 1 mm and 1.1 mm, respectively, and the cores 12 thereof are made of moisture-free air. FIGS. 10 and 11 show that, when the thickness is increased from 1 mm to 1.1 mm, the frequency at the discontinuity shifts. These figures further indicate that non-uniform cladding thickness will reduce the guiding bandwidth.

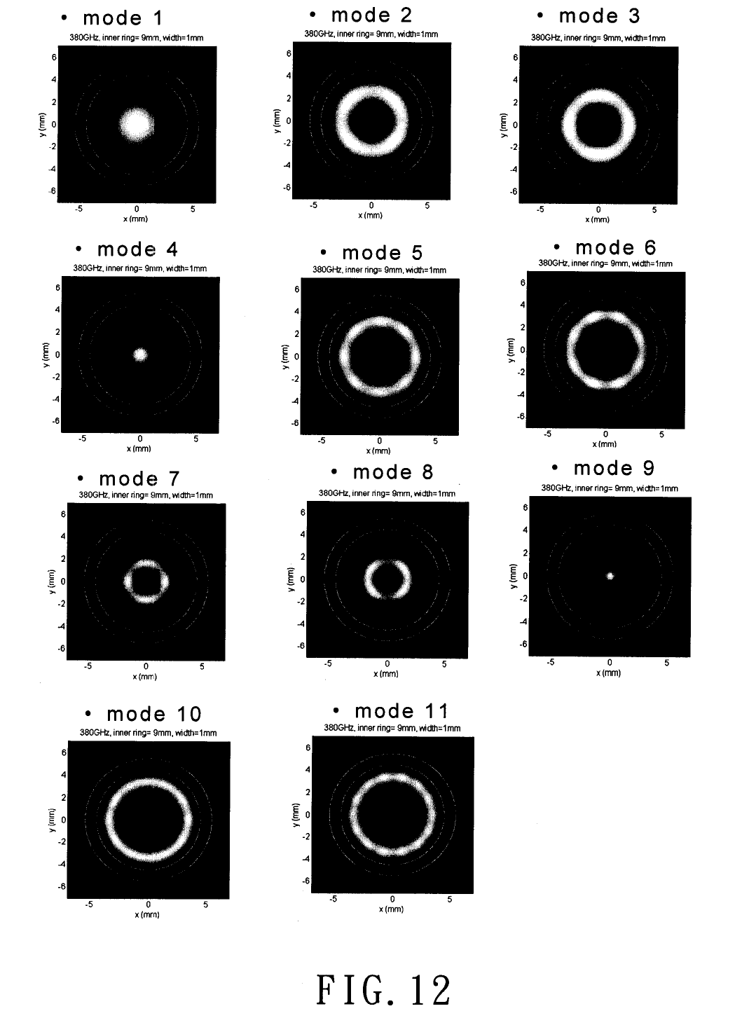

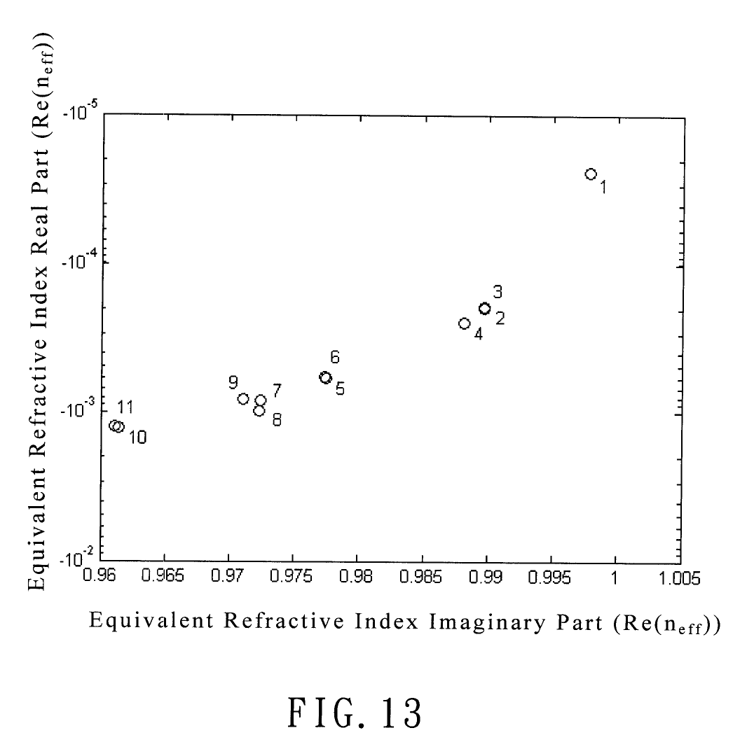

FIG. 12 shows energy intensity distributions of different modes, and FIG. 13 shows the imaginary part of equivalent refractive index as a function of the real part of equivalent refractive index for the waveguide 1 made of Teflon. The inner diameter of the cladding tube 11 of the waveguide 1 is 9 mm, the outer diameter thereof is 10 mm, and the core 12 thereof is made of moisture-free air. The frequency of the transmitted terahertz wave is 380 GHz. Energy intensity distributions for eleven different modes are shown in FIG. 12. Numerals 1-11 in the diagram of FIG. 13 represent modes 1-11 demonstrated in FIGS. 12. From FIGS. 12 and 13, it can be noted that mode 1 (fundamental mode) can transmit the terahertz wave to the farthest distance.

To investigate the dependence of the frequency dependent attenuation constants on core diameter, cladding thickness, and cladding refractive index, simulations of corresponding variations are shown in FIGS. 7, and 14-16. The results demonstrate that the bandwidth is directly proportional to the reciprocal of the cladding thickness, the bandwidth increases as the cladding refractive index decreases, and the attenuation constant decreases as the core diameter increases. Generally speaking, to have a low-loss and high-bandwidth terahertz waveguide, a large air core, a thin cladding layer, and a low-index material are required.

Experiments were made using commercially available Teflon air pipes (refractive index ˜1.4). The experimental results show that the measured bandwidth for the cladding thickness of 0.5 mm is about twice that for a cladding thickness of 1 mm. In addition, for the cladding thickness of 0.5 mm, the available bandwidth is relatively broad with at least 200 GHz, and low attenuation constants are obtained on the order of 0.001 cm⁻¹. Average coupling efficiencies measured for the Teflon waveguides are on the order of 40% for the cladding thickness of 0.5 mm, and the maximum value can be up to 84%. The measurement is performed in un-dehumidified air.

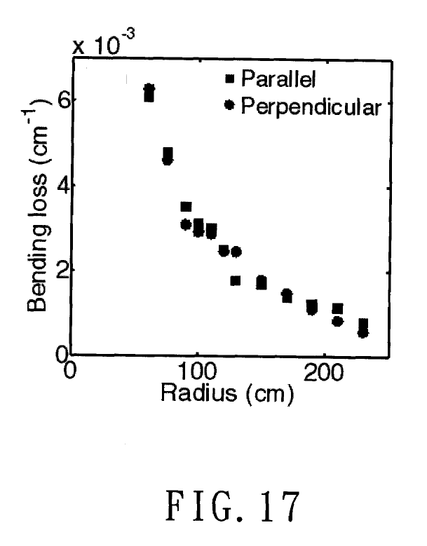

FIG. 17 shows a plot of bending loss of a Teflon pipe as a function of radius of the pipe after the pipe is bent. Bending losses were measured at 420 GHz using a Teflon pipe of 1 meter long with a core diameter of 9 mm and a cladding thickness of 0.5 mm. The difference between polarizations parallel and perpendicular to the bending plane is not significant. The bending losses are smaller than 0.007 cm⁻¹ when the Teflon pipe is bent under a radius of 60 cm. Even when a long Teflon pipe is bent to form a ring with a radius of 22.5 cm, there is still significant THz power delivered at the output end.

While the simulations and experiments described hereinbefore are directed to the terahertz waves having 200 GHz-900 GHz, and the cladding tubes 11 having 7 mm and 9 mm inner diameters and 0.5 mm and 1 mm thicknesses, the waveguide 1 according to the invention is applicable to terahertz waves ranging from 100-3000 GHz, and the inner diameter and the thickness of the cladding tube 11 should not be limited to the dimensions as exemplified hereinbefore. As long as the cladding tube 11 is made of a dielectric material, such as a plastic, or polymeric material (e.g. PE, Teflon, etc.), and as long as the cladding tube 11 does not contain any metal (particularly, ferroelectric material) and is provided with a minimum diameter of the transmission space 113 that is larger than the wavelength of the terahertz wave to be guided, the core 12 and the inner and outer peripheral surfaces 111, 112 of the cladding tube 11 can produce an anti-Fabry-Perot resonance effect so that the terahertz wave is guided and transmitted through the waveguide 1. It is noted that terahertz waves can be transmitted at low transmission loss over a long distance of up to 500 meters by using the waveguide 1.

Moreover, as transmission of the terahertz wave by the waveguide 1 is primarily based on the anti-Fabry-Perot resonance effect generated by the core 12 and the inner and outer peripheral surfaces 111, 112 of the cladding tube 11, the transmission will not be strongly affected by whether or not the cladding tube 11 is wrapped by high lossy metal/ metal alloy, or other material. Furthermore, the transmission is also not significantly affected by the environment. Therefore, the waveguide 1 can transmit the terahertz waves directly in atmospheric air, or moisture-containing air. It is not necessary to provide a specially designed space for the waveguide 1 to transmit the terahertz waves. The waveguide 1 can be used easily, and the construction thereof is simple and can be manufactured at low cost.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A waveguide for guiding a terahertz wave with a wavelength ranging from 0.1 to 3 mm comprising:
a single layer cladding tube made of a metal-free dielectric material, and having an inner peripheral surface, an outer peripheral surface surrounding said inner peripheral surface, and a thickness defined between said inner and outer peripheral surfaces, said inner peripheral surface confining a transmission space; and
a core filling said transmission space, said core having a refractive index lower than that of said cladding tube and a minimum width larger than the wavelength of the guided terahertz wave, said thickness of said cladding tube being smaller than one half of said width of said core;
wherein said core has an attenuation constant for the guided terahertz wave lower than that of said cladding tube.

2. The waveguide of claim 1, wherein said cladding tube has a circular cross section.

3. The waveguide of claim 1, wherein the minimum width of said core is at least twice the wavelength of the guided terahertz wave.

4. The waveguide of claim 1, wherein said core is made of moisture-free air, moisture containing air, moisture-free gas, or a vacuum.

5. The waveguide of claim 1, wherein said thickness of said cladding tube ranges from 0.05 mm to 2 mm.

6. The waveguide of claim 1, wherein said thickness of said cladding tube ranges from 3 mm to 0.05 mm.

7. The waveguide of claim 1, wherein said cladding tube is made of a non-ferroelectric single dielectric material.

8. The waveguide of claim 1, wherein said cladding tube is made of a material selected from the group consisting of polytetrafluoroethylene, polyethylene, and glass.

9. The waveguide of claim 1, wherein the cross section of said cladding tube is elliptical.

10. The waveguide of claim 1, wherein the cross section of said cladding tube is rectangular.

11. A waveguide for guiding a terahertz wave with a wavelength ranging from 0.1 to 3 mm comprising:
a single layer cladding tube of circular cross section made of a metal-free dielectric material, and having an inner peripheral surface, an outer peripheral surface surrounding said inner peripheral surface, and a thickness defined between said inner and outer peripheral surfaces, said inner peripheral surface confining a transmission space; and
an air core filling said transmission space and having a diameter larger than the wavelength of the guided terahertz wave, said thickness of said cladding tube being smaller than the wavelength of the terahertz wave guided by the waveguide;
wherein said core has an attenuation constant for the guided terahertz wave lower than that of said cladding tube.

12. The waveguide of claim 11, wherein said thickness of said cladding tube ranges from 0.05 mm to 2 mm.

13. The waveguide of claim 12, wherein said thickness of said cladding tube is 0.5 mm.

14. The waveguide of claim 13, wherein said cladding tube is made of polytetrafluoroethylene.
